(19) United States
(12) Patent Application Publication
(10) Pub. No.: US 2013/0195281 A1
(43) Pub. Date: Aug. 1, 2013

(54) ASSISTING LISTENING DEVICE HAVING AUDIOMETRY FUNCTION

(71) Applicants: Yung-Yu CHIANG, Taichung City (TW); Hung-Yue CHANG, Taichung City (TW); Ming-Fan WEI, Taichung City (TW)

(72) Inventors: Yung-Yu CHIANG, Taichung City (TW); Hung-Yue CHANG, Taichung City (TW); Ming-Fan WEI, Taichung City (TW)

(73) Assignee: MERRY ELECTRONICS CO., LTD., Taichung City (TW)

(21) Appl. No.: 13/362,403

(22) Filed: Jan. 31, 2012

(51) Int. Cl. H04R 29/00

(52) U.S. Cl. 381/60

(57) ABSTRACT

An assisting listening device having audiometry function includes an earphone, a testing signal generator, a feedback generator and a control box. The testing signal generator is controlled by a digital signal processor of the control box to provide a testing signal to a speaker of the earphone. The feedback generator will generate a feedback signal to the digital signal processor of the control box subject to the testing signal, enabling the digital signal processor to evaluate the user's hearing threshold level so that the user can adjust the functioning of the assisting listening device optimally subject to the evaluation result.

### BACKGROUND OF THE INVENTION

1. Field of the Invention

The present invention relates to assisting listening device technology and more particularly, to a assisting listening device having audiometry function.

2. Description of the Related Art

The so-called assisting listening device is to pick up external sound by a microphone, and then to filter noises or adjust the ambient sound by a digital signal processor (DSP), and then to output filtered sound through a speaker toward the user's eardrum. Thus, any person having a different hearing loss level can join community life easily, improving living quality and maintaining good human relations.

However, even persons with hearing loss wearing an assisting listening device, the hearing condition may deteriorate as grow in age. Conventional assisting listening device designs do not provide any audiometry function. If the user cannot adjust the settings of the assisting listening device subject to the user's hearing loss level, the assisting listening device will be unable to process the picked up external sound optimally, affecting the assisting listening effect of the assisting listening device and causing trouble for the user.

Further, after setting of hearing threshold curve subject to a particular hearing-impaired user, the assisting listening device can simply be used by this hearing-impaired user, not suitable for any other person suffering a different condition of hearing loss. Thus, the application of conventional assisting listening device is limited, lacking in popularity.

### SUMMARY OF THE INVENTION

The present invention has been accomplished under the circumstances in view. It is the main object of the present invention to provide an assisting listening device having audiometry function, which allows adjustment subject the hearing level of different users or a user's different hearing conditions, providing excellent effects of assisting listening.

To achieve this and other objects of the present invention, an assisting listening device comprises an earphone, a testing signal generator, a feedback generator, and a control box. The earphone comprises a microphone, an acoustic signal processor electrically coupled to the microphone, and a speaker electrically coupled to the audio signal processor. The earphone picks up external sound by means of the microphone and converts picked up sound into an acoustic signal. The acoustic signal processor processes the acoustic signal and then transmits the processed signal to the speaker, causing the speaker to emit sound toward the user's eardrum. The testing signal generator is electrically connected to the speaker of the earphone, and adapted to generate a testing signal and transmit the testing signal to speaker. The feedback generator is adapted to generate a feedback signal subject to the testing signal from the testing signal generator. The control box comprises a digital signal processor electrically connected to the acoustic signal processor of the earphone to filter noises from the external sound been picked up by the microphone. The digital signal processor is also electrically connected to the test testing signal generator to control the testing signal generator in generating the testing signal and to receive the feedback signal generated by the feedback generator for evaluating the hearing threshold level of a user.

Further, the feedback generator can be a pushbutton electrically connected to the digital signal processor. When hearing the testing signal generated by the testing testing signal generator, the user can press the pushbutton to provide the feedback signal to the digital signal processor.

Further, the feedback generator can be a microphone electrically connected to the acoustic signal processor of the earphone. When the testing signal from the testing testing signal generator reaches the user's eardrum, the microphone picks up the sound from the eardrum and converts it into a feedback signal, and then transmits this feedback signal through the acoustic signal processor to the digital signal processor of the control box for reading.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of an assisting listening device in accordance with a first embodiment of the present invention.

FIG. 2 is a block diagram of an assisting listening device in accordance with a second embodiment of the present invention.

### DETAILED DESCRIPTION OF THE INVENTION

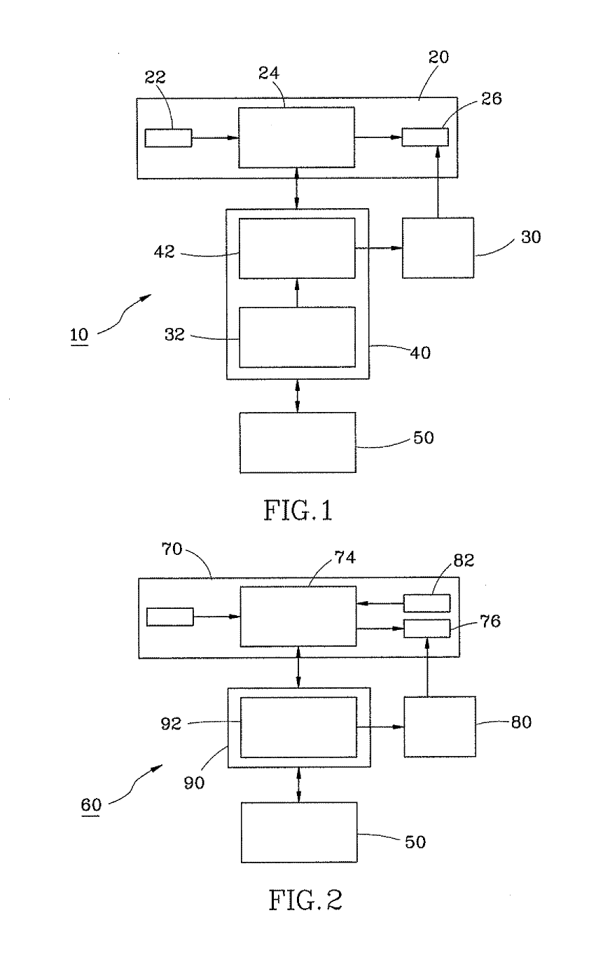

Referring to FIG. 1, an assisting listening device 10 in accordance with a first embodiment of the present invention is shown. The assisting listening device 10 comprises an earphone 20, a testing signal generator 30, a feedback generator 32, and a control box 40. The assisting listening device 10 provides active audiometry function.

The earphone 20 comprises a microphone 22, an acoustic signal processor 24 electrically coupled to the microphone 22, and a speaker 26 electrically coupled to the audio signal processor 24. The earphone 20 picks up external sound by means of the microphone 22 and converts picked up sound into an acoustic signal, which is then processed by the acoustic signal processor 24 and then transmitted by the acoustic signal processor 24 to the speaker 26, causing the speaker 26 to emit sound toward the user's eardrum.

The testing signal generator 30 is electrically connected to the speaker 26 of the earphone 20, and adapted to generate a testing signal and transmit the testing signal to speaker 26. The testing signal can be a pure tone, warble tone or narrow band noise at 500 Hz, 1000 Hz, 2000 Hz or 4000 Hz.

The feedback generator 32 in this embodiment is a pushbutton pressable by an external pressure to generate a feedback signal.

The control box 40 comprises a digital signal processor (DSP) 42, which is electrically coupled with the acoustic signal processor 24 of the earphone 20 for receiving and processing acoustic signal from the acoustic signal processor 24 and then sending filtered acoustic signal back to the acoustic signal processor 24. The digital signal processor (DSP) 42 is also electrically coupled with the testing signal generator 30 and the feedback generator 32 for controlling the testing signal generator 30 to generate a testing signal and receiving and storing the feedback signal from the feedback generator 32 for evaluating the user's hearing condition. Further, the digital signal processor (DSP) 42 and the feedback generator 32 can be integrated in the control box 40.

When the control box 40 enters the normal operating mode, the microphone 22 of the earphone 20 picks up external sound and converts it into an acoustic signal, and then the digital signal processor 42 of the control box 40 filter noises from the acoustic signal and transmits the signal through the acoustic signal processor 24 to the speaker 26, causing the speaker 26 to emit sound toward the user's eardrum, and thus, the user can hear the sound smoothly.

When the control box 40 is switched to the audiometry mode, the digital signal processor 42 transmits a control signal to the testing signal generator 30. At this time, the testing signal generated by the testing testing signal generator 30 will be transmitted through the speaker 26 of the earphone 20 toward the user's eardrum. When heard the sound of the testing signal, the user can press the feedback generator 32, i.e., the pushbutton to provide a feedback signal to the digital signal processor 42 of the control box 40, enabling the digital signal processor 42 to determine the user's hearing level subject to the feedback signal. Determination of the user's hearing level here is to pick up the most suitable one from the various hearing threshold curves defined subject to the user's hearing condition and then to store it in the digital signal processor 42, so that the external sound picked up by the microphone 22 under the normal operating mode can be processed by the digital signal processor 42 subject to the predetermined hearing threshold curve, and then processed by the acoustic signal processor 24 for output through the speaker 26.

Further, the assisting listening device 10 provides a display device 50 electrically connected to the control box 40, facilitating the user to see the audiometry result and to adjust the function of the control box 40. Further, the display device 50 can be integrated in the control box 40.

Further, the aforesaid display device 50 can be disposed in a mobile phone, computer or TV. Further, electrical connection between the earphone 20/control box 40 and the display device 50 can be done by a cable or in a wireless manner.

FIG. 2 illustrates assisting listening device 60 in accordance with a second embodiment of the present invention is shown. This assisting listening device 60 provides a function of passive audiometry, comprising an earphone 70, a testing signal generator 80, and a control box 90. The structure of the earphone 70 of this second embodiment is same as the aforesaid first embodiment.

The testing signal generated by the testing signal generator 80 can be narrow band noise, tone burst or distortion product pure tone at 500 Hz, 1000 Hz, 2000 Hz or 4000 Hz.

The feedback generator 82 in this second embodiment is a microphone integrated in the earphone 70 and electrically connected to the acoustic signal processor 74 of the earphone 70.

When the control box 90 is switched to the audiometry mode, the testing signal generator 80 will be controlled by the digital signal processor 92 to generate a testing signal. When the testing signal is transmitted from the testing signal generator 80 through the speaker 76 to the user's eardrum, the feedback generator 82, which is a microphone in this second embodiment, will automatically pick up the sound from the vibration of the eardrum and convert it into a feedback signal, and then transmit this feedback signal through the acoustic signal processor 74 to the digital signal processor 92 of the control box 90 for determining the hearing threshold level.

Similarly, the digital signal processor 92 of the control box 90 can be electrically connected to a display device 50 to provide the same effects as the aforesaid first embodiment.

Further, the feedback generator 82 can also be used for background noise correction. When the user is in a noisy environment, the assisting listening device can use the feedback generator 82 to pick up sound from the ear canal and then remove the unnecessary noises for determining the user's hearing level accurately.

In conclusion, the assisting listening device of the present invention provides an audiometry function for enabling the user to know his (her) hearing level. Further, the audiometry mode has two different designs. A user can adjust the functioning of the assisting listening device subject to the audiometry result. Or, the digital signal processor of the assisting listening device can automatically adjust the best operating mode subject to the audiometry result to fit different users suffering different degrees of hearing loss, enabling every user to hear sound comfortably and achieving excellent effects of assisting listening.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An assisting listening device, comprising:
an earphone comprising a microphone, an acoustic signal processor electrically coupled to said microphone and a speaker electrically coupled to said audio signal processor;
a testing signal generator electrically coupled to said speaker of said earphone and adapted for providing a testing signal to said speaker;
a feedback generator adapted for generating a feedback signal subject to the testing signal generated by said testing signal generator; and
a control box comprising a digital signal processor electrically connected to said acoustic signal processor of said earphone and said testing signal generator and adapted for controlling said testing signal generator to generate said testing signal and receiving the feedback signal generated by said feedback generator for evaluating the hearing threshold level of a user.

2. The assisting listening device as claimed in claim 1, wherein said feedback generator is a pushbutton integrated in said control box and electrically connected to said digital signal processor and operable by an external pressure to provide said feedback signal to said digital signal processor of said control box subject to said testing signal.

3. The assisting listening device as claimed in claim 2, wherein the testing signal generated by said testing signal generator is a pure tone, warble tone or narrow band noise.

4. The assisting listening device as claimed in claim 1, wherein said feedback generator is a microphone integrated in said earphone and electrically connected to said acoustic signal processor for converting sound emitted by the eardrum subject to said testing signal into said feedback signal and transmitting said feedback signal through said acoustic signal processor to said digital signal processor of said control box.

5. The assisting listening device as claimed in claim 4, wherein the testing signal generated by said testing signal generator is a pure tone, warble tone or narrow band noise.

6. The assisting listening device as claimed in claim 1, further comprising a display device electrically connected to said control box and adapted for displaying the evaluated hearing threshold level.
